(19) United States
(12) Patent Application Publication
(10) Pub. No.: US 2011/0094257 A1
(43) Pub. Date: Apr. 28, 2011

(54) MICRO-CHANNEL HEAT EXCHANGER SUITABLE FOR BENDING

(75) Inventors: Giorgio Rusignuolo, Manlius, NY (US); Tiago Dutra Souza, Porto Alegre (BR)

(73) Assignee: CARRIER CORPORATION, Farmington, CT (US)

(21) Appl. No.: 12/933,303

(22) PCT Filed: Mar. 20, 2009
(86) PCT No.: PCT/US09/01787

§ 371 Date: Dec. 9, 2010

Related U.S. Application Data
(60) Provisional application No. 61/070,221, filed on Mar. 20, 2008.

(51) Int. Cl. F25B 1/00; F28F 9/02; F25B 39/02; B23P 15/26

(52) U.S. Cl. 62/498; 165/175; 62/515; 29/890.052

(57) ABSTRACT

A micro-channel heat exchanger for use in a refrigerant vapor compression system and suitable for bending has two or more separate heat exchange panels joined by a brace. Bending occurs at the brace to eliminate or reduce bending loads and forces on the inlet headers, outlet headers, and heat exchange tubes of the head exchanger to prevent excessive damage to the heat exchanger components.

### BACKGROUND

Refrigerant vapor compression systems are well known in the art. Air conditioners and heat pumps employing refrigerant vapor compression cycles are commonly used for cooling, or both cooling and heating, air supplied to a climate controlled comfort zone within a residence, office building, hospital, school, restaurant or other facility. Conventionally, these refrigerant vapor compression systems include a compressor, condenser, an expansion device, and an evaporator connected in refrigerant flow communication. The aforementioned basic refrigerant system components are interconnected by refrigerant lines in a closed refrigerant circuit and arranged according to the vapor compression cycle employed.

In some refrigerant vapor compression systems, the evaporator is a parallel tube heat exchanger. Such heat exchangers have a plurality of parallel refrigerant flow paths provided by a plurality of tubes extending in parallel relationship between an inlet header and an outlet header. Flat, rectangular or oval shape, multi-channel tubes are used. Each multi-channel tube has a plurality of flow channels extending longitudinally in parallel relationship the length of the tube, each channel providing a small cross-sectional flow area refrigerant flow path. An inlet header receives refrigerant flow from the refrigerant circuit and distributes that refrigerant flow amongst the plurality of flow paths through the heat exchanger. The outlet header serves to collect the refrigerant flow as it leaves the respective flow paths and to direct the collected flow back to the refrigerant line for return to the refrigerant vapor compression system. Thus, a heat exchanger with multi-channel tubes extending in parallel relationship between the inlet and outlet headers of the heat exchanger will have a relatively large number of small cross-sectional flow area refrigerant paths extending between the two headers.

Non-uniform distribution of two-phase refrigerant flow can be a problem in parallel tube heat exchangers which may adversely impact heat exchanger efficiency. Obtaining uniform refrigerant flow distribution amongst the relatively large number of small cross-sectional flow area refrigerant paths is more difficult than in conventional round tube heat exchangers and can significantly reduce efficiency. Arranging the heat exchange tubes in a vertical direction allows for more uniform refrigerant distribution.

In certain applications of refrigerant vapor compression systems, for example, residential air conditioning systems or hydronic chillers and terminals, the parallel tube heat exchanger is required to fit into a particularly-sized housing to minimize the air conditioning system footprint. In other applications, the parallel tube heat exchanger is required to fit into an airflow duct of a particular size. In these instances, it may be necessary to bend or shape the parallel tube heat exchanger to accommodate these special restrictions while ensuring an undiminished ability to cool or heat the climate controlled zone. One practice of bending and shaping parallel tube heat exchangers involves bending the heat exchange assembly around a cylinder. During this process, force is applied to one side of the assembly to wrap it around a partial turn of the cylinder to provide a uniform and reproducible method of bending the assembly. One problem with this method is that the inlet and outlet headers are also bent when the heat exchange tubes are in a vertical orientation (flow in a vertical direction) and the bending axis is a vertical axis. With this orientation and bending, the parts of the inlet and outlet header on the outside of the bend may become excessively stressed and damaged during the bending process. This can result in severely damaged or deformed headers and non-functioning headers. The heat exchange tubes may also be damaged during bending. Damage to the heat exchange tubes reduces their effectiveness and the efficiency of the overall heat exchange process.

### SUMMARY

Exemplary embodiments of the invention include a heat exchanger configuration suitable for bending that reduces or eliminates damage to the heat exchanger components. The heat exchanger is a component of a refrigerant vapor compression system. The heat exchanger has distinct heat exchange panels which may be oriented and configured to fit a desired application. A brace joins adjacent heat exchange panels to provide a single heat exchanger unit.

In one disclosed embodiment, a refrigerant vapor compression system includes a condenser, a compressor, an expansion valve, and a heat exchanger connected in fluid flow communication in a refrigerant circuit. The heat exchanger has at least two heat exchange panels. Each heat exchange panel has a plurality of heat exchange tubes of flattened cross-section, where each heat exchange tube has a plurality of channels extending through the tube and defining a discrete flow path. Each heat exchange panel also has an inlet header for receiving fluid to be distributed to the plurality of flow paths of the heat exchange tubes and an outlet header for collecting fluid that has traversed the plurality of flow paths of the heat exchange tubes. Adjacent heat exchange panels are joined by a brace. The brace has an angle from about 10° to about 180° so that the heat exchange panels can be configured to fit into housings and ducts of particular size for use in a refrigerant vapor compression system.

Further exemplary embodiments include a method of bending a heat exchanger that reduces or eliminates damage to the heat exchanger components. This is accomplished by joining first and second heat exchange panels with a brace to form the heat exchanger followed by bending of the heat exchanger at the brace so that the angle between the first and second heat exchange panels is between about 10° and about 170°.

### BRIEF DESCRIPTION OF THE DRAWINGS

FIG. 1 is a schematic illustration of a refrigerant vapor compression system incorporating the heat exchanger of the invention.

FIG. 2 is an isometric view of a bent parallel tube heat exchange assembly of an exemplary embodiment of the invention.

FIG. 3 is a cross section view of the embodiment of FIG. 1.

FIG. 4 is a cross section view of a first embodiment of an unbent parallel tube heat exchange assembly.

FIG. 5 is a cross section view of a second embodiment of an unbent parallel tube heat exchange assembly.

### DETAILED DESCRIPTION

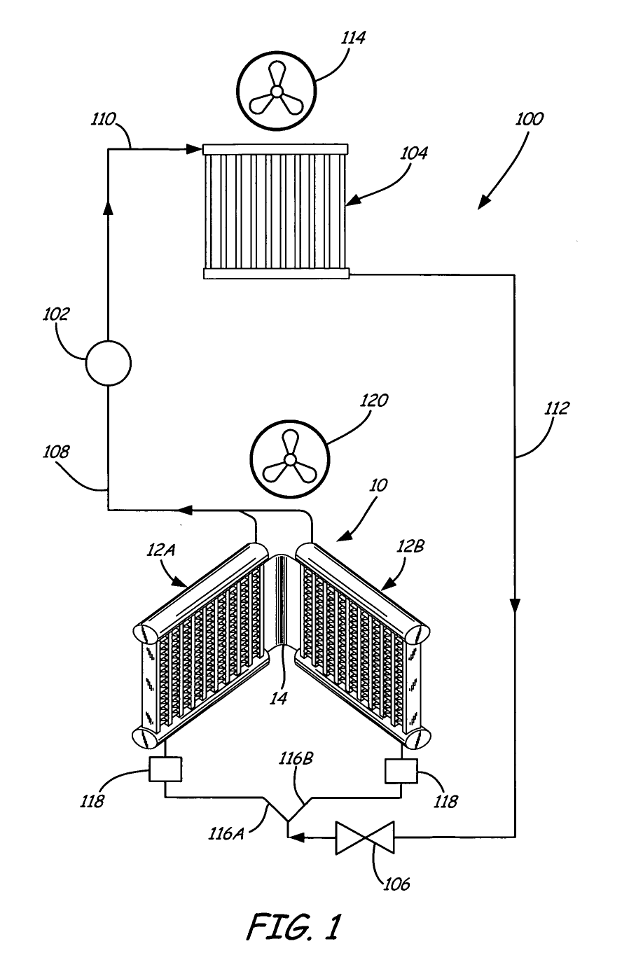

Referring now to FIG. 1, a refrigerant compression system 100 is depicted schematically having a compressor 102, a condenser 104, an expansion valve 106, and the heat exchanger 10 of the invention functioning as an evaporator, connected in a closed loop refrigerant circuit by refrigerant lines 108, 110 and 112. As in conventional refrigeration compression systems, the compressor 102 circulates hot, high pressure refrigerant vapor through refrigerant line 110 into the inlet header of the condenser 104, and then through the heat exchange tubes of the condenser 104 wherein the hot refrigerant vapor condenses to a liquid as it passes in heat exchange relationship with a cooling fluid, such as ambient air which is passed over the heat exchange tubes by the condenser fan 114. The high pressure, liquid refrigerant collects in the outlet header of the condenser 104 and then passes through refrigerant line 112 to the heat exchanger 10. As the liquid refrigerant travels through refrigerant line 112 it passes through expansion valve 106 and thereafter splits into two connecting channel flow paths 116A and 116B as it continues to the heat exchange panels 12A, 12B of the heat exchanger 10. Proper distribution of the liquid refrigerant to the multiple inlet headers 16 of heat exchanger 10 is controlled by regulating means 118.

Regulating means 118 may be provided by controlling the inner diameter of the connecting channel flow path 116. The inner diameter of the connecting channel flow path 116 may be increased to provide increased liquid refrigerant flow into the heat exchange panel 12 connected to the connecting channel flow path 116. Conversely, the inner diameter of a connecting channel flow path 116 may be reduced to provide decreased liquid refrigerant flow into the heat exchange panel 12 connected to the connecting channel flow path 116. The inner diameter of a connecting channel flow path 116 may be determined based on the number of multi-channel heat exchange tubes 20 receiving fluid from the heat exchange panel 12 attached to the connecting channel flow path 116. Other means of regulating flow include micrometric or adjustable flow regulator valves, such as those available from Caleffi S.p.A. (Fontaneto d'Agogna, Italy), thermal expansion valves, electronic expansion valves, or any other type of expansion device.

After entering the heat exchange panels 12A, 12B, the refrigerant then passes through the heat exchange tubes 20 of the heat exchanger 10 wherein the refrigerant is heated as it passes in heat exchange relationship with air to be cooled which is passed over the heat exchange tubes 20 and fins 28 by one or more evaporator fans 120. The refrigerant vapor passes through the heat exchange panels 12A, 12B and continues through refrigerant line 108 to return to the compressor 102 through the suction inlet thereto. Although the exemplary refrigerant compression cycle illustrated in FIG. 1 is a simplified air conditioning cycle, it is to be understood that the heat exchanger of the invention may be employed in refrigerant compression systems of various designs, including, without limitation, heat pump cycles, economized cycles and commercial and transport refrigeration cycles.

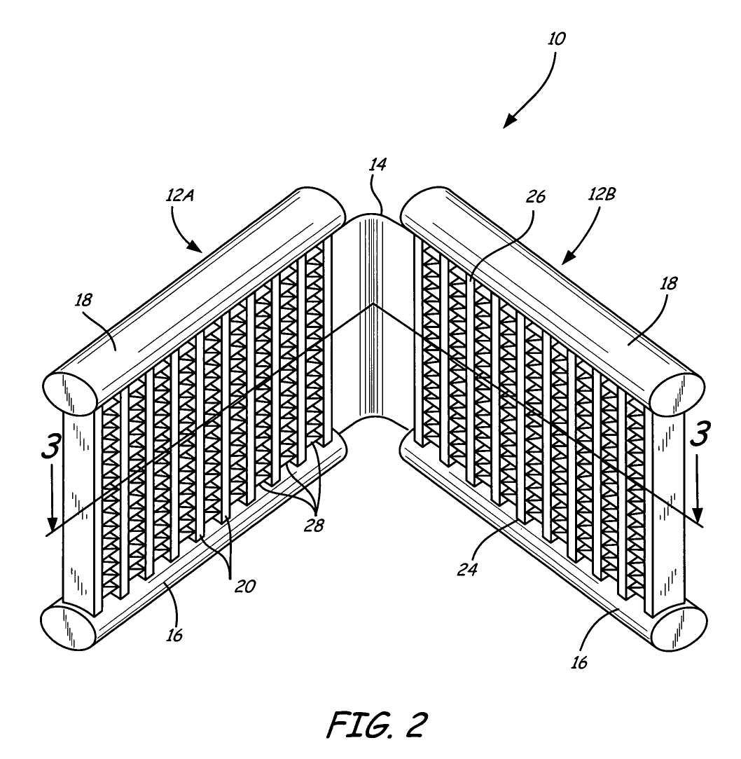

The heat exchanger 10 includes at least two heat exchange panels 12A, 12B joined together by a brace 14 (FIG. 2). Each heat exchange panel includes an inlet header 16, an outlet header 18, and a plurality of multi-channel heat exchange tubes 20 providing a plurality of fluid flow paths between the inlet header 16 and the outlet header 18. In the embodiment depicted in FIG. 2, the heat exchange tubes 20 are arranged vertically, and the inlet headers 16 are located below the plurality of heat exchange tubes 20 and the outlet headers 18 are located above the plurality of heat exchange tubes 20. The positions of the inlet headers and outlet headers are not limited to the depicted configuration. For example, the inlet headers 16 may also be located above the plurality of heat exchange tubes 20 and the outlet headers 18 located below the plurality of heat exchange tubes 20. The inlet headers 16, outlet headers 18, and plurality of heat exchange tubes 20 in a heat exchange panel 12 are generally, but not necessarily, in the same plane.

In the depicted embodiment, the inlet headers 16 and the outlet headers 18 are longitudinally elongated, hollow, closed end cylinders defining fluid chambers of circular cross-section. Neither the inlet headers 16 nor the outlet headers 18 are limited to the depicted configuration. For example, the headers might comprise a longitudinally elongated, hollow, closed end cylinder having a circular or elliptical cross-section or a longitudinally elongated, hollow closed end body having a square, rectangular, hexagonal, octagonal, or other polygonal cross-section. A refrigerant line (not shown) leads into each inlet header 16 and a refrigerant line (not shown) exits from each outlet header 18.

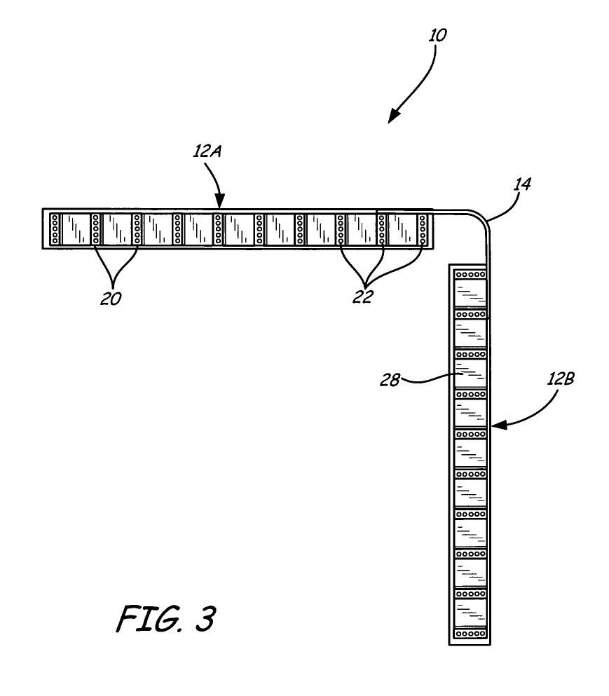

Heat exchange tubes 20 extend between and engage inlet header 16 and outlet header 18. Each heat exchange tube 20 has a plurality of parallel flow channels 22 (shown in FIGS. 3-5) extending longitudinally, i.e. along the axis of the heat exchange tube, the length of the heat exchange tube thereby providing multiple, independent, parallel flow paths between the inlet header 16 to the tube and to the outlet header 18 from the tube. Each multi-channel heat exchange tube 20 is a “flat” tube of, for example, a rectangular or oval cross-section, defining an interior which is subdivided to form a side-by-side array of independent flow channels 22. The flat, multi-channel heat exchange tubes 20 may, for example, have a width of fifty millimeters or less, typically twelve to twenty-five millimeters, and a height of about two millimeters or less, as compared to conventional prior art round tubes having a diameter of either ½ inch, ⅜ inch or 7 mm. In an exemplary embodiment, the heat exchange tubes 20 are aluminum.

Each heat exchange tube 20 has an inlet end 24 opening through the wall of the inlet header 16 into fluid flow communication with the fluid chamber of the inlet header 16 and has an outlet end 26 opening through the wall of the outlet header 18 into fluid flow communication with the fluid chamber of the outlet header 18. Thus, each of the flow channels 22 of the respective heat exchange tubes 20 provides a flow path from the fluid chamber of the inlet header 16 to the fluid chamber of the outlet header 18. The respective inlet ends 24 and outlet ends 26 of the heat exchange tubes 20 may be brazed, welded, adhesively bonded or otherwise secured in a corresponding mating slot in the wall of the headers to provide fluid flow communication.

The heat exchange tubes 20 are shown in drawings hereof, for ease and clarity of illustration, as having five flow channels 22 defining flow paths having a circular cross-section (FIGS. 3-5). However, it is to be understood that in commercial and transport refrigeration applications, such as for example refrigerant vapor compression systems, each multi-channel heat exchange tube 20 will typically have about ten to twenty flow channels 22, but may have a greater or a lesser number of channels, as desired. In some hydronic chiller applications, for example, each heat exchange tube 20 will have only one flow channel 22. Generally, each flow channel 22 will have a hydraulic diameter, defined as four times the flow area divided by the perimeter, in the range from about 200 microns to about 3 millimeters. Although depicted as having a circular cross-section in the drawings, the flow channels 22 may have rectangular, triangular, trapezoidal cross-section or any other desired non-circular cross-section.

In an exemplary embodiment, fins 28 extend between adjacent heat exchange tubes 20. Fins aid the heat exchange process by enhancing the air side heat exchange. The fins 28 are welded or brazed to each heat exchange tube 20 to which it is connected. The fins 28 extend from an outer surface of one heat exchange tube 20 to an outer surface of an adjacent heat exchange tube 20. The fins 28 may be arranged in a generally “V”-shaped pattern. Although fins 28 depicted in FIG. 2 have a first fin substantially perpendicular to the heat exchange flow path and an adjacent second fin joined to one end of the first fin and forming an acute angle between the second and first fins, the fins 28 may be arranged in various other ways.

A brace 14 joins the first heat exchange panel 12A and the second heat exchange panel 12B. The brace 14 does not create a fluid connection between the first and second heat exchange panels 12A, 12B but rather acts as a support to connect the two heat exchange panels. In an exemplary embodiment, brace 14 joins the plurality of heat exchange tubes 20 of the first heat exchange panel 12A with the plurality of heat exchange tubes 20 of the second heat exchange panel 12B. In an alternative embodiment, the brace 14 joins the heat exchange tubes 20 and the inlet headers 16 and/or outlet headers 18 of the two heat exchange panels 12A, 12B. In yet another embodiment, the brace 14 joins the inlet headers 16 and/or outlet headers 18, but does not join the heat exchange tubes 20. The brace 14 may be a metal or alloy such as aluminum, copper, steel, brass, bronze, aluminum alloy, or any other alternative thermal and stress resistant material suitable for bending.

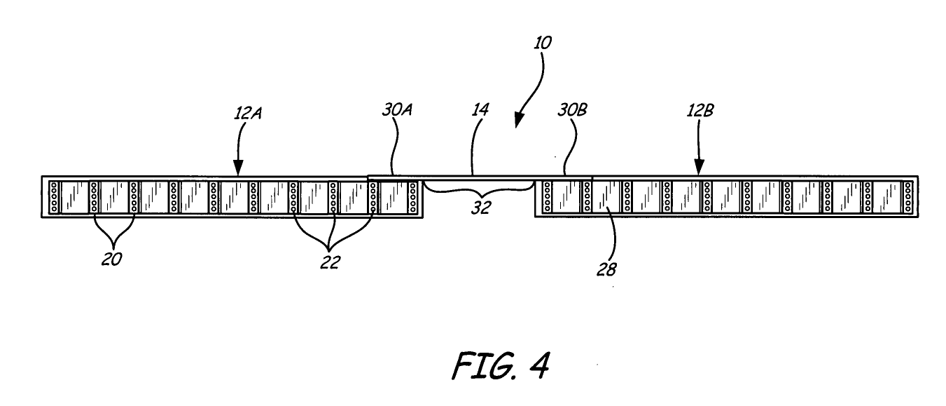

The brace 14 may be welded or brazed to the first and second heat exchange panels 12A, 12B. FIGS. 2-4 depict one embodiment where the brace 14 is joined at back sides of the of the first and second heat exchange panels 12A, 12B. FIGS. 2 and 3 illustrate the heat exchanger 10 and brace 14 in a bent configuration whereas FIG. 4 depicts the heat exchanger configuration where the brace 14 is not bent. As FIG. 4 illustrates, the brace 14 has two end sections 30A, 30B and a center span 32. In this configuration, the two end sections 30A, 30B are welded or brazed to heat exchange tubes 20 of the first and second heat exchange panels 12A, 12B.

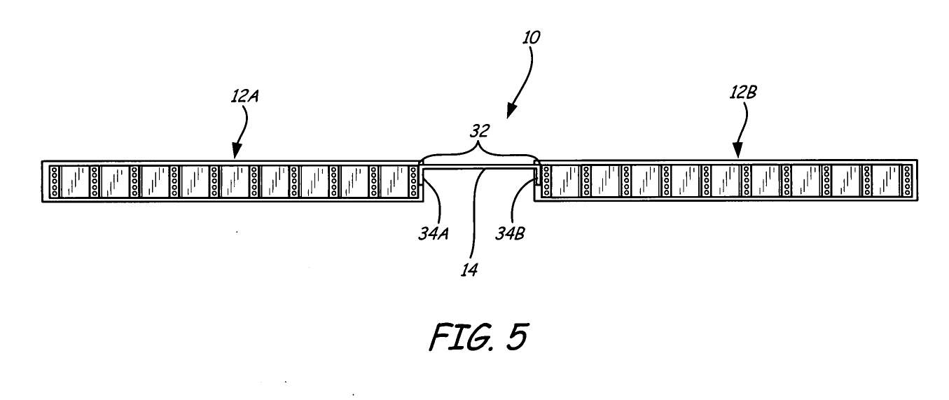

FIG. 5 depicts another embodiment where the brace 14 is joined at longitudinal end sides of the first and second heat exchange panels 12A, 12B. In FIG. 5, the brace 14 has a center span 32 and first and second flanges 34A, 34B. The brace 14 is bent at two 90° angles to form the flanges 34A, 34B and provide additional contact areas with the longitudinal end surfaces of the heat exchange tubes 20 for welding or brazing.

The brace 14 may be welded or brazed to the first heat exchange panel 12A and second heat exchange panel 12B and subsequently bent or the brace 14 may be bent prior to welding or brazing to the first and second heat exchange panels 12A, 12B. Where the brace 14 is bent subsequent to welding or brazing, the use of a mandrel, arbor, lathe or other bending device or tool may be used to bend and shape the brace 14 of the heat exchanger 10. In one embodiment, the brace 14 is bent around a mandrel so that the inlet and outlet headers 16, 18 are not subjected to excessive forces during the bending and shaping process. Bending the heat exchanger 10 after welding or brazing the brace 14 to the first and second heat exchange panels 12A, 12B allows the heat exchanger 10 to be bent to suit the particular needs of a housing or duct. When the bending occurs after the brace 14 is welded or brazed to the heat exchange panels, slight bending of the inlet headers 16 and outlet headers 18 may occur depending on the length of the brace 14 and the degree of the bend performed. Thus, the ends of the inlet headers 16 and outlet headers 18 nearest the brace 14 may be slightly bent in some cases. Even with slight bending, however, the inlet and outlet headers 16, 18 are not subjected to the excessive forces that would be present if no brace was used and the inlet headers 16 and outlet headers 18 were continuous across both heat exchange panels 12A, 12B. In some situations, the bending process does not affect the inlet or outlet headers and they remain in a substantially straight (unbent) configuration.

Where the brace 14 is bent prior to welding or brazing to the first and second heat exchange panels 12A, 12B, the method described above using a mandrel, lathe or other bending device may be used to bend the brace 14. Other suitable methods of bending or shaping the brace 14 may also be used.

Bending the brace 14 rather than the entire heat exchanger components including the inlet headers 16, outlet headers 18, and heat exchange tubes 20 offers several advantages. First, damage to the heat exchanger components is eliminated or minimized. Stress and forces due to the bending process are not exerted upon the heat exchanger components listed above, but merely the brace 14. This allows bending without concern that the heat exchanger 10 will not function as desired. Second, bending only the brace 14 allows for more precise bends. By bending only the brace 14, the heat exchanger 10 can be shaped more freely. The brace 14 can be bent so that it has a rounded bend (as shown in FIGS. 1-3) or so that it forms a sharp right angle, like an “L”. Bending the inlet headers 16, outlet headers 18, and heat exchange tubes 20 all together does not allow for such flexibility in the bending configuration and makes it more difficult to achieve the desired heat exchanger without causing damage.

In an exemplary embodiment, the brace 14 is bent at an angle of about 90°. In this arrangement, the first heat exchange panel 12A and the second heat exchange panel 12B are substantially perpendicular to each other as depicted in FIGS. 2 and 3. This 90° angle bend allows the heat exchanger 10 to fit within a duct or housing that an unbent heat exchanger of equivalent size would not. The heat exchanger 10 of the present invention may also be configured with various other angles between the first and second heat exchange panels 12A, 12B. The angle of the brace 14 may be changed so that the heat exchanger 10 can be fit to an existing housing or duct. The heat exchanger 10 may be configured at angles, both acute and obtuse, from about 10° to about 180°. Other exemplary embodiments may have a brace configured with an angle between about 40° and about 150° or between about 70° and about 120°. Acute angles, such as 40° and 70°, provide for a heat exchanger 10 configured to fit in ducts, housings, and other areas that have very limited space. Obtuse angles, such as 120° and 150°, provide for a heat exchanger 10 configured to fit in ducts, housings, and other areas that may have long yet narrow space availability. An additional benefit of many angled configurations is that a single fan or air moving device may be employed to pass air across both heat exchange panels. At very small acute angles, the degree of bending may be limited by the shape and length of the brace 14, the inlet headers 16, outlet headers 18, and the heat exchange tubes 20.

An unbent configuration is depicted in FIGS. 4 and 5. In this configuration the brace 14 is at an angle of 180° and the first and second heat exchange panels 12A, 12B are substantially parallel. This configuration provides the advantage of allowing future bending possibilities of the heat exchanger 10 without applying excessive forces to the inlet and outlet headers 16, 18.

FIG. 1 illustrates one exemplary embodiment of a system where the heat exchanger 10 is an evaporator, changing a substance from a liquid state into a gaseous state. In another exemplary embodiment, the heat exchanger 10 functions as a condenser, condensing a substance from a gaseous state into a liquid state. In such an embodiment, the heat exchanger 10 would take the place of the condenser 104 in FIG. 1 and another heat exchanger would be used as the evaporator.

While the invention has been described with reference to exemplary embodiments, it will be understood by those skilled in the art that various changes may be made and equivalents be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A heat exchanger comprising:
a first heat exchange panel comprising:
a plurality of first heat exchange tubes, each heat exchange tube having one or more channels extending therethrough, each channel defining a discrete flow path;
a first inlet header for receiving a fluid to be distributed amongst the one or more flow paths of the first heat exchange tubes; and
a first outlet header for collecting a fluid having traversed the one or more flow paths of the first heat exchange tubes;
a second heat exchange panel comprising:
a plurality of second heat exchange tubes, each heat exchange tube having one or more channels extending therethrough, each channel defining a discrete flow path;
a second inlet header for receiving a fluid to be distributed amongst the one or more flow paths of the second heat exchange tubes; and
a second outlet header for collecting a fluid having traversed the one or more flow paths of the second heat exchange tubes; and
a brace joining the first heat exchange panel and the second heat exchange panel at an angle between about 10° and about 180° along an axis.

2. The heat exchanger of claim 1, wherein the pluralities of first and second heat exchange tubes traverse vertical axes.

3. The heat exchanger of claim 2, wherein the brace is bent along a vertical axis.

4. The heat exchanger of claim 1, wherein the brace joining the first and second heat exchange panels is metal.

5. The heat exchanger of claim 1, wherein the brace is welded, brazed, or fastened to the pluralities of first and second heat exchange tubes.

6. The heat exchanger of claim 1, wherein a substantial portion of the first inlet header and a substantial portion of the second inlet header are at an angle corresponding to the angle between the plurality of first heat exchange tubes and the plurality of second heat exchange tubes.

7. The heat exchanger of claim 6, wherein a substantial portion of the first outlet header and a substantial portion of the second outlet header are at an angle corresponding to the angle between the plurality of first heat exchange tubes and the plurality of second heat exchange tubes.

8. The heat exchanger of claim 7, wherein each of the first and second inlet headers and each of the first and second outlet headers have a substantially straight longitudinal axis.

9. The heat exchanger of claim 7, wherein each of the first and second inlet headers and each of the first and second outlet headers comprise an internal end proximal to the brace and an external end, wherein the inlet headers and outlet headers near the internal end have a generally curved flow path.

10. The heat exchanger of claim 1, wherein a plurality of fins are attached between adjacent heat exchange tubes of the pluralities of the first and second heat exchange tubes.

11. The heat exchanger of claim 1, wherein the brace is bent such that the plurality of first heat exchange tubes and the plurality of second heat exchange tubes form an angle of about 40° to about 150°.

12. The heat exchanger of claim 11, wherein the brace is bent such that the plurality of first heat exchange tubes and the plurality of second heat exchange tubes form an angle of about 70° to about 120°.

13. A refrigerant vapor compression system comprising:
a condenser, a compressor, an expansion valve, and an evaporator connected in fluid flow communication in a refrigerant circuit, wherein at least one of the condenser and the evaporator comprises:
a first heat exchange panel comprising:
a plurality of first heat exchange tubes, each heat exchange tube having one or more channels extending therethrough, each channel defining a discrete flow path;
a first inlet header for receiving a fluid to be distributed amongst the one or more flow paths of the first heat exchange tubes; and
a first outlet header for collecting a fluid having traversed the one or more flow paths of the first heat exchange tubes;
a second heat exchange panel comprising:
a plurality of second heat exchange tubes, each heat exchange tube having one or more channels extending therethrough, each channel defining a discrete flow path;
a second inlet header for receiving a fluid to be distributed amongst the one or more flow paths of the second heat exchange tubes; and
a second outlet header for collecting a fluid having traversed the one or more flow paths of the second heat exchange tubes; and
a brace joining the first heat exchange panel and the second heat exchange panel at an angle between about 10° and about 180° along an axis.

14. The refrigerant vapor compression system of claim 13, wherein the first and second inlet headers are connected to the expansion valve by first and second connecting channels.

15. The refrigerant vapor compression system of claim 14, wherein an internal diameter of the connecting channel is proportional to a relative quantity of flow paths fed by the inlet header joined to the connecting channel.

16. The refrigerant vapor compression system of claim 14, wherein the connecting channel further comprises a valve with means for regulating flow of fluid through the valve.

17. The refrigerant vapor compression system of claim 13, wherein the pluralities of first and second heat exchange tubes traverse vertical axes and the brace is bent along a vertical axis.

18. A method of bending a heat exchanger, the method comprising:
joining a first heat exchange panel and a second heat exchange panel with a brace to form a heat exchanger; and
bending the heat exchanger at the brace so that an angle between the first heat exchange panel and the second heat exchange panel is between about 10° and about 170°.

19. The method of bending a heat exchanger of claim 18, wherein joining the first heat exchange panel and the second heat exchange panel with the brace comprises welding or brazing the brace to the first and second heat exchange panels.

20. The method of bending a heat exchanger of claim 18, wherein a mandrel, arbor or lathe is used to aid bending of the heat exchanger at the brace.

21. The method of bending a heat exchanger of claim 19, wherein the brace is welded or brazed to the pluralities of first and second heat exchange tubes.
